(19) United States
(12) Patent Application Publication
(10) Pub. No.: US 2025/0199212 A1
(43) Pub. Date: Jun. 19, 2025

(54) DIFFUSER PLATE HAVING AN EXTRUDED LAYER FOR COLOR CONVERSION

(71) Applicant: QTech Co., Ltd., Pyeongtaek-si (KR)

(72) Inventors: Dong Wook KIM, Seoul (KR); Chang Kun KIM, Cheongju-si (KR); Su Jong RYU, Cheonan-si (KR); Hyeong Jun KIM, Suwon-si (KR); Cheol Soo PARK, Hwaseong-si (KR); Hong Myung NA, Suwon-si (KR)

(21) Appl. No.: 18/731,265

(22) Filed: Jun. 1, 2024

(30) Foreign Application Priority Data
Dec. 13, 2023 (KR) 10-2023-0181115
Jan. 11, 2024 (KR) 10-2024-0004820

(51) Int. Cl. G02B 5/02; B82Y 20/00; B82Y 40/00

(52) U.S. Cl. CPC G02B 5/0294; B82Y 20/00; B82Y 40/00; G02B 5/0268; G02B 2207/101; G02B 2207/113

(57) ABSTRACT

A diffuser plate having an extruded layer for color conversion includes: a barrier film including a first barrier film and a second barrier film; a color conversion layer extruded between the first barrier film and the second barrier film, and having Cd-free QDs dispersed in a resin matrix of the color conversion; and a diffuser layer on at least one of the first barrier and the second barrier film, wherein the Cd-free QDs are embedded in beads, wherein the beads are thermally cured to passivate the Cd-free QDs while extruding the color conversion layer.

### CROSS-REFERENCE TO RELATED APPLICATION

This application claims priority to Korean Patent Application No. 10-2023-0181115, filed on Dec. 13, 2023 and 10-2024-0004820, filed on Jan. 11, 2024, the contents of which are incorporated herein by reference in their entirety.

### TECHNICAL FIELD

The present invention relates to a multi-layered diffuser plate, particularly to a diffuser plate having quantum dots (QDs) in at least one layer. The diffuser plate can be used in fields such as displays, lightings, etc.

BACKGROUND OF INVENTION

QDs are nano-crystalline particles having band gaps discontinuous depending on their size and narrow full width at half maximum (FWHM). QDs emit distinctively colored light. Smaller QDs have larger bandgaps and emit shorter wavelength. QOs, for example, selectively absorb an incoming blue light and emit red light or green light with a high color purity.

The size of QDs ranges roughly 0.5 nm˜1000 nm. Visible light is produced from QDs in a size of approximately 1 nm˜10 nm. The average diameter of QDs can be measured using a Scanning Tunneling Microscopy (STM), Light Scattering, and Transmission Electron Microscope (TEM), etc.

The smaller the size of QDs, surface defects tend to be more prominent. QDs having core/shell structures were developed to reduce the surface defects. The core is covered by the shell that has a wider bandgap than that of the core. Various types of core/multiple-shell QDs are also suggested to reduce the lattice mismatch between the core and the shell.

The core materials include metal phosphides such as InP, GaP and AlP; metal selenides such as CdSe, ZnSe and MgSe; and metal tellurides such as CdTe and ZnTe.

The shell materials include CdS, CdSe, CdTe, ZaSe, ZnTe, GaP InP and GaAs which emit visible light; InP, InAs, InSb, PbS and PbSe which emit near-infrared light; ZnS, GaN, MgS, MgSe and MgTe which emit ultraviolet light.

Conventionally, cadmium (Cd) based QDs were used since Cd based QDs have superior quantum efficiency and stability. Recently however, the use of Cd is restricted in the United States, Europe, etc. As a result, Cd-free QDs such as InP, ZnSe, CIS and CZIS were developed. InP/ZnS core-shell QDs are used in displays.

QDs used in the industry typically has organic ligands bound to the inorganic nano-crystalline particles. QDs are supplied in the form of colloidal aqueous dispersions or colloidal solutions, which refers to colloidal QDs. Ligands play a role in maintaining the colloidal stability of QDs and passivating the surface defects of QDs. QDs in the colloidal dispersions can be encapsulated to protect the nano-crystalline particles from the chemical environments and to provide a means of chemical linkage to other inorganic, organic or biological material. In an example, InP/ZnS Core/Shell QDs encapsulated in polycarbonate are disclosed in US patent publication no. 2011/0241229.

QDs have good color purity with a narrow emission spectrum and tunable optical properties with size control capabilities. Due to their spectral purity, QDs can be used to improve white light generated by LEDs. QDs are considered as excellent color conversion and self-emitting materials for display and lighting applications.

Displays such as QLED or QD-LCD, includes light guide plates, diffuser plates, QD films, optical sheets and liquid crystal layers. The diffuser plate diffuses and scatters the light coming from the light source, thereby enhancing uniformity and brightness of the light emitting from the diffuser plate. Blue LEDs are typically used for the light source. An example of the QD film is disclosed in US patent publication no. 2015-0047765. Typically, the QD film is produced by photo-curing a resin emulsion containing QDs between gas barrier films.

An optical plate incorporating the functions of the diffuser plate and the QD film may provide benefits of cost reduction and convenience in the process of assembling display modules. The problem is the stability of Cd-free QDs. Cd-free QDs have physical and chemical properties that are different from Cd-based QDs. The stability of Cd-free QDs are significantly lower than that of Cd based QDs. Cd-free QDs are easily degraded by oxygen, water and heat.

### SUMMARY OF THE INVENTION

The present invention is based on the recognition of the related art described above and provides a diffuser plate which incorporates the feature of the conventional QD film therein. The present invention also aims to provide a diffuser plate with an extruded color conversion layer which has Cd-free QDs dispersed therein.

The Cd-free QDs may be easily deteriorated by the heat for extrusion. The present invention aims to provide a solution to prevent or reduce the deterioration of the Cd-free QDs when extruding the color conversion layer.

The present invention also aims to provide a diffuser plate with superior barrier characteristics to ensure quantum efficiency of the Cd-free QDs in the color conversion layer and/or prolong the lifespan of the Cd-free QDs.

The present invention also aims to provide a method for manufacturing the diffuser plate mentioned above.

The problems to be solved by the present invention are not necessarily limited to those mentioned above, and other purposes not mentioned above may be understood by the following description.

A diffuser plate according to one embodiment of the present invention comprises a barrier film including a first barrier film and a second barrier film; a color conversion layer extruded between the first barrier film and the second barrier film; and a diffuser layer on at least one of the first barrier film and the second barrier film.

The color conversion layer has Cd-free QDs dispersed in a resin matrix of the color conversion layer. The Cd-free QDs in the color conversion layer may include green QDs and red QDs. The Cd-free QDs may have core/shell structures with ligands. The types, structures, etc. of the Cd-free QDs are not restricted.

The first and second barrier films are composed of ready-made barrier films. Preferably, the WVTR (water vapor transmission rate) of the barrier films is no more than 0.5 g/m²-day.

According to one embodiment, the Cd-free QDs are embedded or entrapped in beads which are thermal-cured to passivate the Cd-free QDs while extruding the color conversion layer. The beads are formed at an early stage in the process of extruding the color conversion layer. The beads are thermal-cured composites containing the Cd-free QDs and dispersed in the resin matrix of the color conversion layer.

According to one embodiment, the beads are formed by reaction between an epoxy functional silane (epoxy silane) and an ion exchange resin while extruding the color conversion layer.

According to one embodiment, the color conversion layer is formed by extruding a mixture comprising a colloidal dispersion of the Cd-free QDs, the epoxy silane, the ion exchange resin and a base resin.

The beads have cross-links between an epoxy silane and an ion exchange resin. The reaction temperature between the epoxy silane and the ion exchange resin is below the melting temperature of the base resin.

According to one embodiment, the color conversion layer further comprises a thiol compound. The thiol compound is added in the mixture to form the beads.

According to one embodiment, the diffuser plate also includes optical layers and/or patterns formed a surface of the diffuser plate.

According to one embodiment, the color conversion layer includes two or more layer. The color conversion layer, for example, includes a first layer with green QDs and second layer with red QDs.

A diffuser plate according to one embodiment includes multiple layers formed by co-extrusion. The co-extruded multiple layers form a main part of the diffuser plate. The co-extruded multiple layers may include a diffusion layer and a color conversion layer. The diffuser plate includes a barrier layer on the diffusion layer or on the color conversion layer.

### BRIEF DESCRIPTION OF DRAWINGS

Embodiments of the present invention will be more clearly understood from the following detailed description taken in conjunction with the accompanying drawings in which:

FIG. 1 shows a schematic cross-section of a diffuser plate according to one embodiment of the present invention.

FIG. 2 shows a schematic cross-section of a color conversion layer according to one embodiment of the present invention.

FIG. 3 shows a schematic cross-section of a diffuser plate according to another embodiment of the present invention.

FIG. 4 shows a method for manufacturing the diffuser plate of FIG. 3.

FIG. 5 shows a schematic cross-section of a diffuser plate according to another embodiment of the present invention.

FIG. 6 shows a manufacturing process of a diffuser plate according to one embodiment of the present invention.

### DETAILED DESCRIPTION OF THE INVENTION

Hereinafter, the present invention will be described in detail with reference to the accompanying drawings. In the accompanying drawings, the same or equivalent components or parts are usually denoted by same or similar reference numerals for convenience and easy understanding, and the drawings may be exaggerated or schematically illustrated for a clear understanding and explanation of the features of the invention.

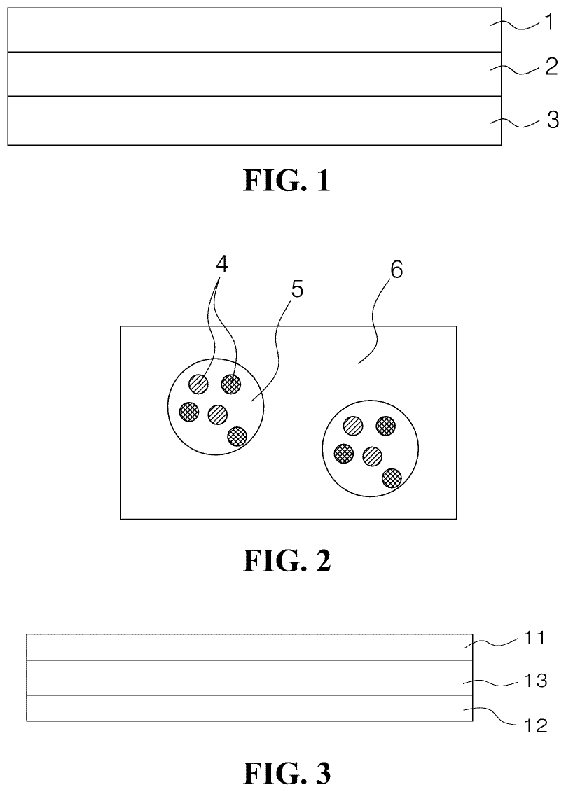

FIG. 1 shows a schematic cross-section of a diffuser plate according to one embodiment.

Referring to FIG. 1, the diffuser plate comprises a color conversion layer 2 and a diffusion layer 1,3.

The diffusion layer 1,3 includes a first diffusion layer 1 and a second diffusion layer 3. At least one of out of the first diffusion layer 1 and the second diffusion layer 3 is co-extruded with the color conversion layer 2.

In an example, the color conversion layer 2 and the diffusion layer 1,3 are made using a same base resin. The base resin is selected from the group of poly styrene (PS), poly methylmethacrylate (PMMA), poly carbonate (PC), poly ethylene (PE) and poly propylene (PP). Polystyrene is used for the base resin of the color conversion layer 2 and the diffusion layer 1,3, for example. The diffusion layer 1,3 contains additives such as light diffuser additives.

The color conversion layer 2 contains Cd-free QDs dispersed in the resin matrix of the color conversion layer 2. The Cd-free QDs need to be protected when extruding the color conversion layer 2 since the Cd-free QDs are easily deteriorated by heat, water and air. The Cd-free QDs are entrapped and protected in a plurality of thermal-cured beads which are formed in the process of extruding the color conversion layer 2.

The diffuser plate may further have a barrier layer (not shown in FIG. 1) provided on at least one of the first diffusion layer 1 and a second diffusion layer 3.

FIG. 2 shows a schematic cross-section of a color conversion layer according to one embodiment.

As shown in FIG. 2, the color conversion layer 2 has a resin matrix 6 and Cd-free QDs 4 dispersed in the resin matrix 6. The Cd-free QDs 4 are passivated by the thermal-cured beads 5. The Cd-free QDs 4 include green QDs and red QDs.

The beads 5 are formed by thermal curing between an epoxy silane and an ion exchange resin in the process of extruding the color conversion layer 2. The beads 5 are cross-linked composites between the epoxy silane and the ion exchange resin containing the Cd-free QDs 4 therein. The epoxy silane and the ion exchange resin react to each other to form the beads 5 and the Cd-free QDs 4 are entrapped in the beads 5 in an early stage of the process of extruding the color conversion layer 2. The beads 5 are described as spherical in FIG. 2, however, may have various shapes.

It is notable that the beads 5 to passivate the Cd-free QDs 4 are formed in the process of extruding the color conversion layer 2. QD dispersion solutions, namely colloidal dispersions of QDs as purchased can be used as raw material for extruding the color conversion layer 2. The QD dispersion solution usually includes QD particles each having ligands and a solvent.

According to one embodiment, the epoxy silane comprises at least one of 3-glycidoxypropyl trimethoxysilane (CAS no. 2530-83-8), 3-glycidoxypropyl triethoxysilane (CAS no. 2602-34-8), 3-glycidoxypropyl methyldimethoxysilane (CAS no. 65799-47-5), and 3-glycidoxypropyl methyldiethoxysilane (CAS no. 2897-60-1). All of these silanes contain 3-glycidoxypropyl. Preferably, the epoxy silane is a liquid at room temperature.

According to one embodiment, the ion exchange resin contains at least one functional group of trimethyl ammonium and quaternary ammonium. As a preferable example, the ion exchange resin is a strong base anion exchange resin with the functional group of quaternary ammonium. Desirably, the ion exchange resin and the base resin of the color conversion layer 2 have a same or similar backbone structure. When PS is used for the base resin of the color conversion layer, Amberlite™ IRA-402 (Cl) is preferable for the ion exchange resin. IRA-402 (Cl) is a gel type ion exchange resin based on a co-polymer of styrene and divinylbenzene. Preferably, the ion exchange resin is a liquid at room temperature.

According to one embodiment, thiol compound is used to form the beads 5. The thiol compound has a SH functional group. The SH functional group is referred to as either a thiol group, mercapto group or sulfhydryl group. The thiol compound has a strong affinity on the surface of QDs and helps stabilization of QDs. Preferably, a thiol monomer and/or a thiol oligomer are used as the thiol compound. Preferably, the thiol compound is a liquid at room temperature.

The thiol compound comprises at least one of 3,3′-dithiobis(propyl acrylate); 1,6-hexanedithiol diacrylate; acryloxyethyl thiopropionate; 3-mercaptopropionic acid 2-acryloyloxyethyl ester; tri (ethylene glycol) acrylate mercaptopropionate; 2-methyl-2-acrylamidopropane-1-thiol; and 3-mercaptopropionic acid acrylate.

A manufacturing method for a diffuser plate according to one embodiment is described hereunder.

The diffuser plate has co-extruded three layers as shown FIG. 1. The diffuser plate includes a color conversion layer, a first diffusion layer, and a second diffusion layer. The color conversion layer contains Cd-free QDs dispersed in a resin matrix of the color conversion layer. The Cd-free QDs embedded in the thermal-cured beads.

Raw material for the color conversion layer is prepared. The raw material includes a colloidal dispersion of the Cd-free QDs, an epoxy silane, an ion exchange resin and a first base resin. The colloidal dispersion of the Cd-free QDs, the epoxy silane and the ion exchange resin are premixed to obtain a premixed solution. The raw material may further include a thiol compound and the thiol compound also can be premixed. And then, the premixed solution is mixed with the first base resin. The materials can be directly mixed with the first base resin without making the premixed solution.

QDs can be purchased in the form of a colloidal dispersion. QDs are dispersed in a solvent such as hexane, heptane, octane, chloroform, and toluene. Appropriate solvents can be selected depending on QDs, especially on types of ligands. Typically, hexane and toluene are used as the solvent.

The colloidal dispersion of the Cd-free QDs is used as provided. The colloidal dispersion, the epoxy silane and the ion exchange resin are used in an appropriate ratio. Preferably, 5 to 25 parts of the epoxy silane to 1 part of the ion exchange resin by weight is used. Preferably, 1 to 10 parts of the colloidal dispersion, 5 to 25 parts of the epoxy silane, and 0.5 to 5 parts of ion exchange resin are used per 100 parts of the base resin, respectively by weight. The weight of the Cd-free QD particles in the colloidal dispersion is considered when calculating mixing ratios of the materials. 0.1 to 4 parts of the Cd-free QD particles per 100 parts of the first base resin, by weight respectively, are used to form the color conversion layer. The thiol compound is used 10 to 100 times the weight of the Cd-free QD particles.

After mixing the colloidal dispersion the Cd-free QDs, the epoxy silane, the ion exchange resin and the first base resin using a mixer, the mixture is poured into a conical hopper of an extruder to form the color conversion layer. Poly styrene is used as the first base resin, for example.

The diffusion layers are co-extruded with the color conversion layer. A second base resin and light diffuser additives are used to form the diffusion layers. A masterbatch containing the light diffuser additives can be used. Poly styrene is used as the second base resin, for example. 1 to 6 parts of the light diffuser additives per 100 parts of the second base resin is used, by weight respectively.

The extruder is configured to provide a high shear stress on the materials therein and to apply vacuum pressure to exhaust gases generated in the barrel of the extruder. The barrel is heated to give heat to the base resin melting in the barrel. As an example, the extruder has four zones. An example of setting the temperatures at the zones are as follows. The zone 1 is an input side near the conical hopper and the zone 4 is an output side of the T-die of the extruder. The temperatures of the zone 2 to 4 are set to melt the base resin.
Zone 1: 180° C.
Zone 2: 220° C.
Zone 3: 230° C.
Zone 4: 230° C.
T-die: 230° C.

Experimental examples of the diffuser plates having the co-extruded three layers as shown FIG. 1 are described hereunder.

### Example 1

Example 1 of the diffuser plate is manufactured.

Nanosys's colloidal dispersion of QDs (IG535), Momentive's gamma (γ)-glycidoxypropyl trimethoxysilane (Silquest A-187™), and Rohm and Hass's ion exchange resin AMBERLITE™ IRA-402 (Cl) are prepared to the color convention layer. The QDs are free of cadmium, and includes green QDs and red QDs. Specific information about IG535 is not given from Nanosys. The solvent of the colloidal dispersion evaporates rapidly in the extrusion process. A-187™ is an epoxy functional silane having a structure of Formula 1 shown as below. A-187™ is a reactive bonding additive and coupling agent for polyurethane, epoxy, polysulfide and acrylic resins. IRA-402 (Cl) consists of trimethyl ammonium groups attached to a styrene-divinylbenzene copolymer matrix formed through methylene linkages wherein the chloride atoms are the replaceable ionic species.

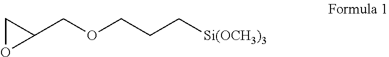

The colloidal dispersion of the QDs, A-187™ and IRA-402 (Cl) are premixed in the ratio of 20:70:10 respectively by weight. Sinopec's GPPS 525, colorless and highly transparent General Purpose Polystyrene, is used as a base resin for the color convention layer.

The base resin GPPS and the premixed solution are mixed in the ratio of 80:20 by weight. The base resin GPPS is supplied in the form of chips or pellets as usual from the resin maker. The mixture of the base resin GPPS and the premixed solution is poured into an extruder and extruded to form the color conversion layer. At an early stage, for example between the zone 1 and the zone 2, the thermal-cured beads are formed by reaction between A-187™ and the quaternary ammonium of IRA-402 (Cl). Before the GPPS resin is melted, the beads are formed and the QDs are entrapped in the beads. The melting point of the GPPS resin is 150 to 180° C. It seems that the beads are formed at a temperature below 100° C.

The diffusion layer is obtained by mixing the GPPS 525 resin from Sinopec and an light diffuser additive masterbatch from KC Chemical and extruding this mixture. The mixing ratio of the GPPS resin and the masterbatch is 80:20 by weight. The masterbatch contains about 20t % by weight of SiO₂ particles in PS resin matrix. The diffusion layer is co-extruded with the color conversion layer.

### Example 2

Example 2 is produced using the same procedure as set out above in Example 1 except that colloidal dispersion of the QDs, A-187™ and IRA-402 (Cl) are used in the ratio of 20:75:5 respectively by weight. The epoxy silane A-187™ is used a little bit more in Example 2 than in Example 1.

### Example 3 (Comparative)

Example 3 is manufactured in the same way as Example 1 except that A-187™ and IRA-402 (Cl) are not used in the color conversion layer. The colloidal dispersion of QDs only is mixed with the GPPS 525 resin to form the color conversion layer. The mixing ratio of the colloidal dispersion of QDs and the GPPS resin is 96:4 by weight.

The optical properties of Example 1 to 3 are measured, and the results are summarized in Table 1 to Table 3.

TABLE 1

| | Category | | |
|---|---|---|---|
| | Optical Property | | |
| | Brightness(cd/m²) | x-axis | y-axis |
| White | 273 | 0.338 | 0.393 |
| Color Gamut | Red | 0.677 | 0.314 |
| | Green | 0.292 | 0.675 |
| | Blue | 0.147 | 0.053 |

| | |
|---|---|
| NTSC(%) | 92.4 |
| DCI(%) | 96.0 |

Table 1 shows the results of Example 1.

As shown in Table 1, in the case of Example 1, the white luminance is 273 cd/m² and the CIE XY chromaticity coordinates are 0.338, 0.393. The chromaticity coordinates of the three primary colors are as shown in Table 1. The color gamut is 92.4% based on NTSC (National Television System Committee) and 96.0% based on DCI (Digital Cinema Initiatives).

TABLE 2

| | Category | | |
|---|---|---|---|
| | Optical Property | | |
| | Brightness(cd/m²) | x-axis | y-axis |
| White | 289 | 0.333 | 0.405 |
| Color Gamut | Red | 0.674 | 0.314 |
| | Green | 0.291 | 0.677 |
| | Blue | 0.147 | 0.053 |

| | |
|---|---|
| NTSC(%) | 92.4 |
| DCI(%) | 96.0 |

Table 2 shows the results of Example 2.

As shown in Table 2, in the case of Example 2, the white luminance is 289 cd/m² above Example 1 and the CIE XY chromaticity coordinates are 0.333, 0.405. The chromaticity coordinates of the three primary colors are as shown in Table 2. The color gamut is 92.4% in NTSC and 96.0% in DCI.

Table 3 shows the results of Example 3.

TABLE 3

| | Category | | |
|---|---|---|---|
| | Optical Property | | |
| | Brightness(cd/m²) | x-axis | y-axis |
| White | 200 | 0.325 | 0.395 |
| Color Gamut | Red | 0.612 | 0.295 |
| | Green | 0.284 | 0.620 |
| | Blue | 0.146 | 0.052 |

| | |
|---|---|
| NTSC(%) | 73.1 |
| DCI(%) | 76.0 |

As shown in Table 3, in the case of Example 3, the white luminance value is 200 cd/m² and the CIE XY chromaticity coordinates are 0.325, 0.395. The chromaticity coordinates of the three primary colors are as shown in Table 3. The color gamut is 73.1% in NTSC and 76.0% in DCI. As shown in the results of Tables 1 to 3, the brightness and the color gamut of Examples 1 and 2 is superior than those of the Example 3.

Accelerated degradation tests are performed with respect to Examples 1 to 3. Samples of Examples 1 to 3 are placed in a Constant Temperature and Humidity Chamber at a temperature of 60° C. and a relative humidity of 90%. The storage time of the samples is 96 hours and 250 hours. The results are summarized in Tables 4 to 6.

Table 4 shows the results of Example 1.

TABLE 4

| | 0 Hour | | | 96 Hours | | | 250 Hours | | |
|---|---|---|---|---|---|---|---|---|---|
| Category | Brightness | x | y | Brightness | x | y | Brightness | x | y |
| White | 273 | 0.338 | 0.393 | 275 | 0.336 | 0.391 | 274 | 0.335 | 0.390 |
| Color | Red | 0.677 | 0.314 | Red | 0.669 | 0.313 | Red | 0.668 | 0.313 |
| Gamut | Green | 0.292 | 0.675 | Green | 0.291 | 0.673 | Green | 0.293 | 0.673 |
| | Blue | 0.147 | 0.053 | Blue | 0.146 | 0.053 | Blue | 0.146 | 0.052 |

| | | | |
|---|---|---|---|
| NTSC | 92.4% | 90.6% | 90.3% |
| DCI | 96.0% | 94.3% | 94.0% |

As shown in Table 4, in Example 1, the white luminance and the color gamut decrease over time, however the amount of decrease is small. The white luminance value (cd/m²) and the color gamut value (%) at 250 hours are smaller than those at 96 hours, however the values of both cases can be considered to be almost the same level. In the case of Example 1, the white luminance and the color gamut decreases over time, however, the rate of decrease is not high, and the white luminance and the color gamut appear to be maintained at a high level to some extent.

Table 5 shows the results of Example 2.

TABLE 5

| | 0 Hour | | | 96 Hours | | | 250 Hours | | |
|---|---|---|---|---|---|---|---|---|---|
| Category | Brightness | x | y | Brightness | x | y | Brightness | x | y |
| White | 289 | 0.333 | 0.405 | 295 | 0.338 | 0.396 | 296 | 0.337 | 0.397 |
| Color | Red | 0.674 | 0.314 | Red | 0.671 | 0.314 | Red | 0.669 | 0.313 |
| Gamut | Green | 0.291 | 0.677 | Green | 0.290 | 0.678 | Green | 0.291 | 0.676 |
| | Blue | 0.147 | 0.053 | Blue | 0.146 | 0.052 | Blue | 0.145 | 0.053 |

| | | | |
|---|---|---|---|
| NTSC | 92.4% | 92.0% | 91.2% |
| DCI | 96.0% | 95.7% | 94.9% |

As shown in Table 5, in Example 2 the decreases of optical properties over time are smaller than those in Example 1. The white luminance values (cd/m²) at 96 hours and 250 hours are higher than those at the beginning of 0 hour. Even considering errors, these results show that the decrease in the white luminance value over time may be minimal.

Table 6 shows the results of Example 3.

TABLE 6

| | 0 Hour | | | 96 Hours | | | 250 Hours | | |
|---|---|---|---|---|---|---|---|---|---|
| Category | Brightness | x | y | Brightness | x | y | Brightness | x | y |
| White | 200 | 0.325 | 0.395 | 172 | 0.335 | 0.382 | 148 | 0.285 | 0.311 |
| Color | Red | 0.612 | 0.295 | Red | 0.586 | 0.284 | Red | 0.575 | 0.272 |
| Gamut | Green | 0.284 | 0.620 | Green | 0.281 | 0.615 | Green | 0.273 | 0.522 |
| | Blue | 0.146 | 0.052 | Blue | 0.143 | 0.051 | Blue | 0.143 | 0.049 |

| | | | |
|---|---|---|---|
| NTSC | 73.1% | 68.8% | 55.4% |
| DCI | 76.0% | 71.6% | 57.7% |

As shown in Table 6, in the case of Example 3, the optical properties are not good at the beginning of 0 hour and also significantly deteriorate over time, comparing Examples 1 and 2. After 250 hours, the white luminance value (cd/m²) of Example 3 was only 50% of that of Example 2, and the color gamut was only 60% of that of Example 2.

As can be seen from the reliability test results in Tables 4 to 6, it can be understood that Examples 1 and 2 have better optical properties than Example 3 from the beginning and that the degradation rates over time also are very low in the case of Examples 1 and 2 comparing Example 3. When comparing Example 1 and Example 2, Example 2 shows better optical properties than Example 1. The epoxy silane A-187™ is used a little bit more in Example 2 than in Example 1.

The barrier layers are not applied in Examples 1 to 3. If the barrier layer is applied to Examples 1 to 3, the degradation of optical properties over time may be greatly reduced. The barrier layer may be interposed between the color conversion layer and the diffusion layer, or may be disposed on each outer surface of the diffusion layers 1 and 3 in FIG. 1.

According to one embodiment, a thiol compound is added as raw material to form the color conversion layer. The thiol compound includes at least one of thiol monomers and thiol oligomers. The thiol compound is liquid at room temperature. The thiol compound participates in the formation of the beads at the early stage of extrusion of the color conversion layer. The thiol compound is used 10 to 100 times the weight of the QD particles. It is notable that the thiol compound is used not 10 to 100 times the weight of the colloidal dispersion of QDs. Examples of the thiol compound which is commercially available and applicable to the embodiment are 3M's light-curable Thiol-Ene Oligomer 510 and Sartomer™ SR9021. SR9021 is a propoxylated glyceryl triacrylate having a molecular weight of 573 and available from SARTOMER.

FIG. 3 shows a schematic cross-section of a diffuser plate according to one embodiment.

Referring to FIG. 3, the diffuser plate is configured such that the color conversion layer 13 is in direct contact with the barrier layers 11 and 12. As in the embodiments described above, QDs are entrapped in the beads which are dispersed in the matrix of the color conversion layer 13. The QDs are protected by the beads and the barrier layers from moisture and air. The QDs are free of are free of cadmium, and contains green and red QDs.

According to another embodiment, the color conversion layer 13 includes two or more layers. The color conversion layer, for example, includes a first conversion layer with green QDs and second conversion layer with red QDs.

According to another embodiment, commercially available or separately produced barrier films are used for the barrier layers 11 and 12. The barrier layers 11 and 12 consist of the first barrier film 11 and the second barrier film 12, respectively. The color conversion layer 13 is extruded between the barrier layers 11 and 12. The barrier films 11 and 12 require a high level of ability not to allow gas and water to pass through and high transmittance for the visible light. A polyethylene terephthalate (PET) film on which Ag or Al is deposited are used for the barrier films 11 and 12, for example.

A diffusion layer is provided on the barrier films 11 and 12. The diffusion layer includes a first diffusion layer on the outer surface of the first barrier film 11, and a second diffusion layer on the outer surface of the second barrier film 12.

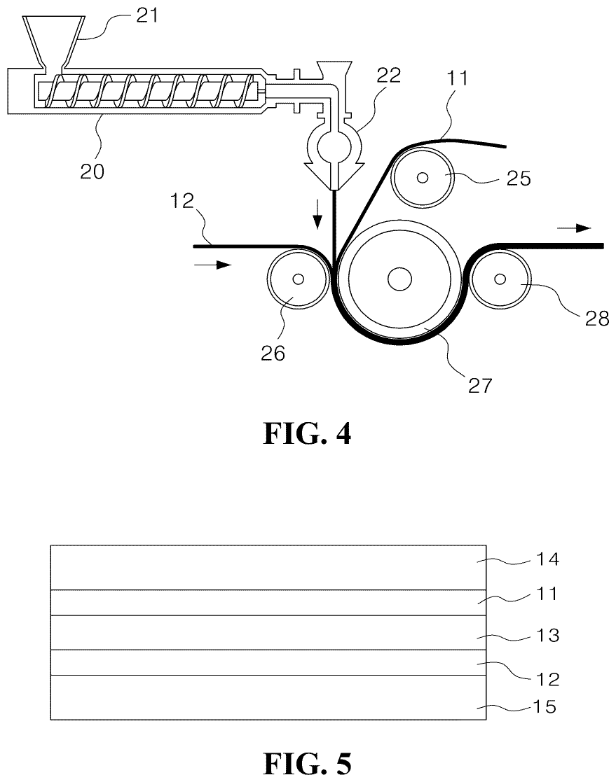

FIG. 4 shows a method for manufacturing such diffuser plate in FIG. 3.

The raw material for the color conversion layer 13 are prepared 13 as described in Example 1. The prepared raw material are poured into the hopper 21 of the extruder 20. At an early stage of the extrusion, the thermal-cured beads are formed by reaction between A-187™ and the quaternary ammonium of IRA-402 (Cl) and the Cd free QDs are entrapped and protected in the beads from the heat in the barrel of the extruder 20.

The raw material for the color conversion layer 13 is extruded from the T-die 22 of the extruder 20. A cooling roll 27 is disposed directly below the T-die 22. The first barrier film 11 is supplied to one side of the extruded color conversion layer 13, and the second barrier film 12 is supplied to the other side of the extruded color conversion layer 13. The color conversion layer 13 with the barrier films 11 and 12 are rolled out through the cooling roll 27 and the pressure rolls 26 and 28. In an example, the barrier films 11 and 12 are made of PET, and the base resin of the color conversion layer 13 is GPPS.

The color conversion layer 13 may have the functionality of the diffusion layer. However, in reality, a separate diffusion layer is needed. For example, a diffusion layer is provided on at least one of the first barrier film 11 and the second barrier film 12.

FIG. 5 shows a schematic cross-section of a diffuser plate according to one embodiment.

Referring to FIG. 5, the diffuser plate has a color conversion layer 13, barrier films 11 and 12, and diffusion layers 14 and 15. The color conversion layer 13 are formed by extruding between the first barrier film and the second barrier film 11 and 12 as shown in FIG. 4. The diffusion layers 14 and 15 are provided on the barrier films 11 and 12, respectively. The QDs in the color conversion layer 13 are embedded in the thermal-cured beads.

Polystyrene (PS), polymethyl methacrylate (PMMA) and polycarbonate (PC) can be used for the base resin of the diffusion layer. The diffusion layer contains light diffusing agents such as TiO2 particles to scatter or spread the incident light over a wide angular range.

The diffusion layers 14 and 15 may be composed with commercially available diffusion films. The diffusion films can be laminated on or attached to the barrier films.

The diffusion layers 14 and 15 may be formed after the extrusion process shown in FIG. 4. For example, at the end of the extrusion process line of FIG. 4, another process line for coating or extruding the diffusion layer on the outer surface of the barrier film is provided.

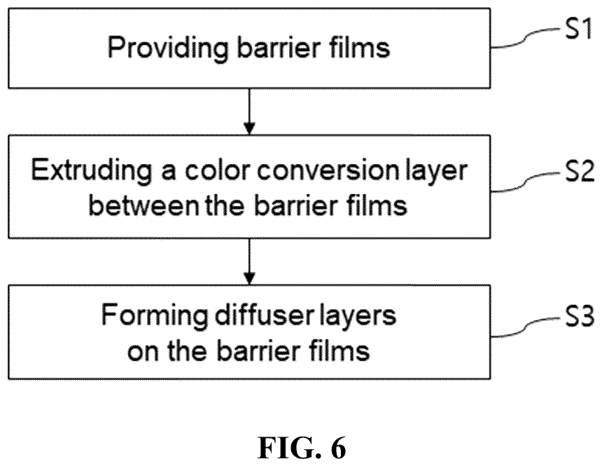

Referring to FIG. 6, a method for manufacturing a diffuser plate comprises providing barrier films, forming a color conversion layer by extruding a mixture containing Cd-free QDs between the barrier films, and forming diffuser layers on the barrier films. The Cd-free QDs are embedded in beads. The beads are composites containing the Cd-free QDs therein and cured thermally at an early stage in the process of extruding the color conversion layer.

According to the present invention, the diffuser plate with the functionality of the conventional QD film can be provided.

Also, it is possible to manufacture the diffuser plate with the color conversion layer by extrusion. Mass production of diffuser plates by extrusion process is possible.

Also, deterioration of non-cadmium QDs is prevented or reduced during the extrusion process. Non-cadmium QDs are entrapped in the beads formed at the early stage of extrusion process and protected from the heat during the extrusion process.

And further, the beads provide superior barrier properties together with the barrier film, ensures the quantum efficiency of the QDs in the color conversion layer, and prolong the lifespan of the QDs and the diffuser plate.

While specific embodiments of the present invention have been illustrated and described, it will be understood by those skilled in the art that changes may be made to those embodiments without departing from the spirit and scope of the invention that is defined by the following claims.

What is claimed is:

1. A diffuser plate having an extruded layer for color conversion, comprising:
a barrier film including a first barrier film and a second barrier film;
a color conversion layer extruded between the first barrier film and the second barrier film, and having Cd-free quantum dots (QDs) dispersed in a matrix of the color conversion layer; and
a diffuser layer on at least one of the first barrier film and the second barrier film.

2. The diffuser plate of claim 1,
wherein the Cd-free QDs are embedded in a plurality of thermal-cured beads having cross-links between an epoxy silane and an ion exchange resin.

3. The diffuser plate of claim 2,
wherein the ion exchange resin contains at least one functional group of trimethyl ammonium and quaternary ammonium.

4. The diffuser plate of claim 2,
wherein at least one of the beads includes a thiol compound.

5. A method for manufacturing a diffuser plate, comprising:
providing a first barrier film and a second barrier film,
forming a color conversion layer by extruding a mixture between the first barrier film and the second barrier film, and
forming a diffuser layer on at least one of the first barrier film and the second barrier film,
wherein the mixture comprises a colloidal dispersion of Cd-free quantum dots (QDs), an epoxy silane, an ion exchange resin and a base resin,
wherein the Cd-free QDs are embedded in a plurality of thermal-cured beads,
wherein the beads are formed by a reaction between the epoxy silane and the ion exchange resin while extruding the color conversion layer,
wherein the mixture contains 5 to 25 parts by weight of the epoxy silane per 1 part by weight of the ion exchange resin.

6. The method of claim 5,
wherein the epoxy silane is selected from the group consisting of 3-glycidoxypropyl trimethoxysilane, 3-glycidoxypropyl triethoxysilane, 3-glycidoxypropyl methyldimethoxysilane, 3-glycidoxypropyl methyldiethoxysilane, and a combination thereof.

7. The method of claim 5,
wherein the ion exchange resin contains at least one functional group of trimethyl ammonium and quaternary ammonium.

8. The method of claim 5,
wherein the mixture further comprises a thiol compound.

9. The method of claim 8,
wherein the thiol compound is selected from the group consisting of 3,3′-dithiobis(propyl acrylate); 1,6-hexanedithiol diacrylate; acryloxyethyl thiopropionate; 3-mercaptopropionic acid 2-acryloyloxyethyl ester; tri (ethylene glycol) acrylate mercaptopropionate; 2-methyl-2-acrylamidopropane-1-thiol; 3-mercaptopropionic acid acrylate; and a combination thereof.
